(19) United States
(12) Patent Application Publication
(10) Pub. No.: US 2021/0024427 A1
(43) Pub. Date: Jan. 28, 2021

(54) CMC SYSTEM FOR IMPROVED INFILTRATION

(71) Applicant: Rolls-Royce Corporation, Indianapolis, IN (US)

(72) Inventors: David Noel Liliedahl, Fishers, IN (US); Chong Mo Cha, Carmel, IN (US)

(73) Assignee: Rolls-Royce Corporation, Indianapolis, IN (US)

(21) Appl. No.: 16/522,248

(22) Filed: Jul. 25, 2019

(51) Int. Cl. C04B 35/80; C04B 35/628; C04B 35/657

(52) U.S. Cl. CPC C04B 35/80; C04B 35/62844; C04B 35/62884; C04B 2235/616; C04B 2235/5256; C04B 2235/5268; C04B 2235/614; C04B 35/657

(57) ABSTRACT

A method is provided in which multiple layers are formed. Each of the layers includes at least a first set of ceramic fibers and a second set of ceramic fibers. The first set is arranged at an angle with respect to the second set. The first set and the second set define a plurality of pores therebetween. The layers are arranged on top of each other to form a porous preform. The pores of the layers arranged on top of each other are aligned. The pores define a plurality of channels extending continuously through the porous preform from a first side of the porous preform to a second side of the porous preform. Each channel comprises one inlet at the first side of the porous preform and one outlet at the second side of the porous preform. The porous preform is infiltrated with a matrix material.

### TECHNICAL FIELD

This disclosure relates to ceramic matrix composites and, in particular, to fabrication of ceramic matrix composites and to uniquely structured ceramic matrix composite components.

### BACKGROUND

Ceramic matrix composites (CMCs), which include ceramic fibers embedded in a ceramic matrix, exhibit a combination of properties that make them promising candidates for industrial applications that demand excellent thermal and mechanical properties along with low weight, such as gas turbine engine components. Accordingly, there is a need for inventive systems and methods including CMC materials described herein.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates a schematic view of an example of a porous preform;

FIG. 2 illustrates a schematic view of an example of a layer of the porous preform;

FIG. 3A illustrates a cross-sectional schematic view of the example of the porous preform of FIG. 1;

FIG. 3B illustrates a cross-sectional schematic view of another example of the porous preform;

FIG. 4A illustrates a cross-sectional schematic view of another example of the porous preform;

FIG. 4B illustrates a cross-sectional schematic view of another example of the porous preform;

FIG. 5 illustrates a schematic view of an example of a ceramic matrix composite (CMC) component; and

FIG. 6 illustrates a flow diagram of an example for a method for manufacturing the CMC component of FIG. 5.

### DETAILED DESCRIPTION

In one example, a method is provided in which multiple layers are formed. Each of the layers includes at least a first set of ceramic fibers and a second set of ceramic fibers. The first set is arranged at an angle with respect to the second set. The first set and the second set define a plurality of pores therebetween. The layers are arranged on top of each other to form a porous preform. The pores of the layers arranged on top of each other are aligned. The pores define a plurality of channels extending continuously through the porous preform from a first side of the porous preform to a second side of the porous preform. Each channel comprises one inlet at the first side of the porous preform and one outlet at the second side of the porous preform. The porous preform is infiltrated with a matrix material.

In another example, a method is provided in which at least one layer of ceramic fibers is formed. The layer is part of a complete porous preform. The layer includes multiple pores. The pores define multiple channels extending continuously through the complete porous preform from a first side of the complete porous preform to a second side of the complete porous preform. Each channel includes one inlet at the first side of the complete porous preform and one outlet at the second side of the complete porous preform. The complete porous preform is infiltrated with a matrix material.

In yet another example, a ceramic matrix composite (CMC) component is provided including ceramic fibers embedded in a matrix material. The CMC component further includes multiple infiltrated channels comprising the matrix material. The channels extend from a first side of the CMC component to a second side of the CMC component. The first side is opposite of the second side.

Processes involving vapor infiltration into woven or porous materials are used in various manufacturing applications. For example, chemical vapor infiltration (CVI) may be used to chemically deposit a matrix material into woven carbon fibers during the manufacturing of carbon matrix composite (CMC) components and/or materials. The vapor infiltration process often causes a delay in the manufacturing process because the matrix material diffuses relatively slowly through the woven carbon fibers. Generally speaking, the woven carbon fibers in each layer are arranged randomly with respect to woven carbon fibers in the other respective layers. As a result, vapor infiltration into the woven and/or porous materials is slow because the vapor must diffuse through complex, tortuous paths with restrictive pores. As additional matrix material is deposited during the vapor infiltration process, the pores become smaller and thus further restrict the flow of vapor through the pores, which slows the vapor infiltration process even further. The geometric characteristics of the pores impact the processing time for the woven materials and, as such, play a major factor in determining the cost of producing the CMC component.

One interesting feature of the systems and methods described below may be that two-dimensional, 3D weaves, and/or porous preforms may have aligned pores, which define channels that pass through the porous preform. The channels may provide a decreased loss of effective diffusivity and/or permeability during deposition of the matrix material compared to systems having randomly arranged pores. Alternatively, or in addition, an interesting feature of the systems and methods described below may be that the layers may be spaced apart a predetermined distance that is greater than spacing in systems having randomly arranged pores and/or layers. The increase in distance between layers may further minimize a loss in permeability and/or diffusivity.

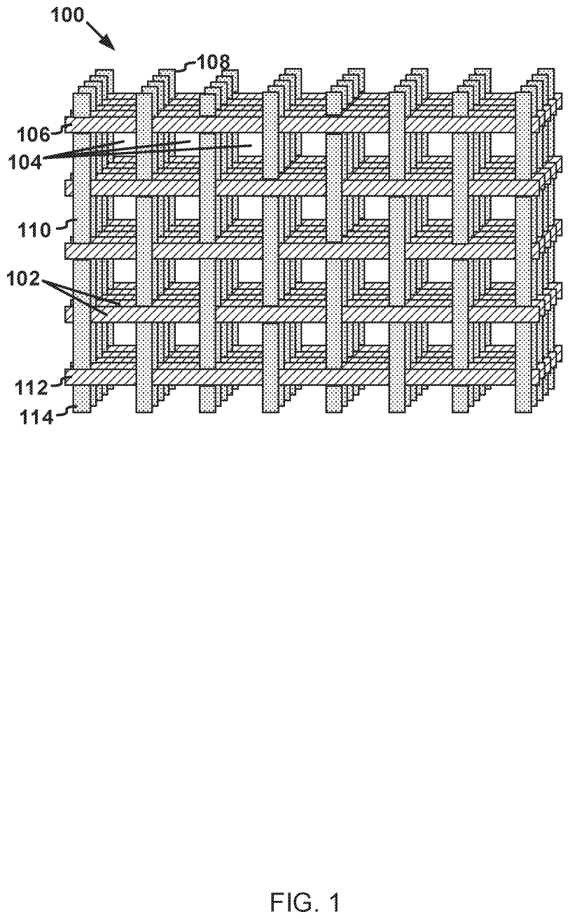

FIG. 1 is a perspective view of an example of a porous preform 100 of a component for a gas turbine engine. The porous preform 100 may be any porous preform configured to be infiltrated with a ceramic material, for example, by chemical vapor infiltration (CVI) and/or melt infiltration. In some examples, the porous preform 100 may be a two-dimensional or 3-D ceramic fiber preform, which forms a structural scaffold for subsequent infiltration of a ceramic matrix. Additionally, the porous preform 100 may be a complete preform that, after infiltration, may be an entire CMC component. To make the ceramic fiber preform, chopped fibers, continuous fibers, unidimensional tape, and/or woven fabrics are laid up, fixed, and shaped into a configuration of a desired CMC component. In some examples, the porous preform 100 may be a preform for an entire component of a gas turbine engine. In other examples, the porous preform 100 may be a preform for only a portion of the component of the gas turbine engine. Examples of components for the gas turbine engine may include, but are not limited to, combustor liners, compressor blades, turbine blades, nozzle guide vanes, seal segments, any other components that may be exposed to combustion temperatures (hot-section components), and any other components that may be designed to have a physical property of CMC. The entire component is any discrete component, which may or may not be a part of a larger component.

In the example shown in FIG. 1, the porous preform 100 includes layers 102 of ceramic fibers 110, which define channels 104 extending through the layers 102 from a first side 106 of the porous preform 100 to a second side 108 of the porous preform 100. For clarity reasons, only a subset of the layers 102 are designated with the reference number 102 in the figure, and only a subset of the channels 104 are designated with the reference number 104. Similarly, only a subset of the ceramic fibers 110 are designated with the reference number 110. In the illustrated example, the first side 106 of the porous preform 100 is positioned opposite the second side 108. In some examples, the porous preform 100 may include multiple layers 102 stacked together. In other examples, the porous preform 100 may be a single 3-D weave of ceramic fibers.

Each one of the layers 102 may include any arrangement of the ceramic fibers 110. The layer 102 of the ceramic fibers 110 may be fixed in a predetermined shape. Examples of the layer 102 may include woven cloths, woven sheets, unidirectional tape, polar woven cloths, two-dimensional weaves, and 3D woven structures.

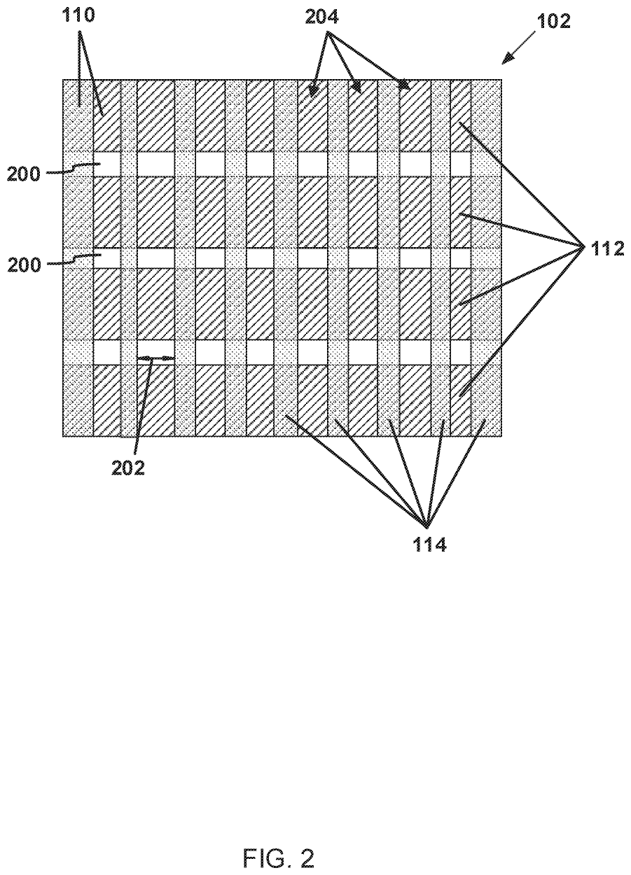

In some examples, the ceramic fibers 110 may include at least a first set 112 of ceramic fibers, such as weft, and a second set 114 of ceramic fibers, such as warp. An example of the layer 102 is further illustrated in FIG. 2. As shown in FIGS. 1 and 2, in some examples the first set 112 of the ceramic fibers 110 may be arranged perpendicular to the second set 114. In other examples, the first set 112 and the second set 114 may be arranged at a predetermined angle with respect to each other. The first set 112 and the second set 114 may define a grid pattern. In yet further examples, the layer 102 may include additional sets and/or non-uniform sets (not shown) of ceramic fibers arranged at different angles throughout the layers, such that layer has a non-uniform pattern. As shown in FIG. 1, the layers 102 may be square shaped. In other examples, the layer 102 may be rectangular, parabolic, annular, or any other shape.

In an example where the layer 102 is a woven sheet of the ceramic fibers 110, the first set 112 and second set 114 may be warp and weft tows, where weft tows are transverse with respect to the warp tows. In this example, the weft tows are woven through, over-and-under, adjacent warp tows.

The complete preform is any porous preform that, if infiltrated, results in the entire component. In particular, the complete preform represents the entire preform from which the entire component is produced. As a result, when the complete preform is subjected to, for example, CVI, then the vapor introduced as part of the CVI process may directly enter the channels 104 from outside of the complete preform from the first side 106 and/or the second side 108.

As shown in FIG. 2, the first set 112 of the ceramic fibers 110 and the second set 114 of the ceramic fibers 110 may define a series of pores 200 between the ceramic fibers 110. Each of the pores 200 may be an aperture or hole having a perimeter defined by two of the ceramic fibers 110 in the first set 112 and two of the ceramic fibers 110 of the second set 114. Each of the pores 200 may have a diameter 202. In some examples, all pores 200 on a single layer 102 may have substantially equal diameters. In other examples, some of the pores 200 on a single layer 102 may have a different diameter than other pores 200 on the same layer 102. In examples where the layer 102 is a 3-D weave, the layer 102 may include a third set of ceramic fibers orthogonally weaving through the first set 112 and the second set 114. In the illustrated layer 102, a single one of the pores 200 defines part of a corresponding one of the channels 104. In other examples, as shown in FIG. 1, the layers 102 are stacked, such that the pores 200 of the stacked layers 102 are aligned. In such an example, the aligned pores 200 define the channels 104. The pores 200 may have a square shaped cross section as in the example illustrated in FIG. 2. In other examples, the cross section of the pores 200 may be circular, elliptical, rectangular, or any other shape.

The diameter 202 may be in a range between 10×F-500×F where F is a width of the smallest fiber of the ceramic fibers 110 in a given layer 102. In examples where the ceramic fibers 110 include tows, or bundles, of fibers, the diameter 202 of the pores 200 is greater than the space between the fibers in a given tow. For example, the diameter 202 may be in a range between 0.1×T-5×T, where T is a width of the smallest tow of a given layer 102 of the ceramic fibers 110. In some examples, if T is the smallest width of the smallest tow, then the smallest pore diameter, P, is approximately equal to 0.1T.

Each of the layers 102 may further include minor pores 204, which are uncrossed gaps between adjacent ceramic fibers 110 of the first set 112 or the second set 114. For example, as shown in FIG. 2, each of the minor pores 204 may be spaces between adjacent ceramic fibers of the second set 114 further bounded by one or more of the ceramic fibers 110 of the first set 112 passes underneath (into the page) and/or over (out of the page).

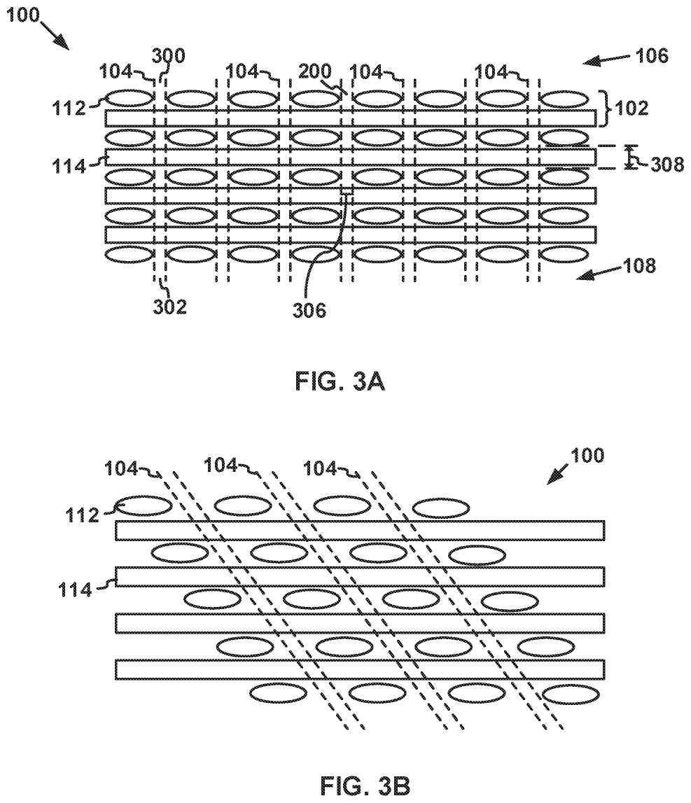

FIG. 3A is a schematic view of a cross section of an example of the porous preform 100. Each of the channels 104 may be any conduit configured to receive a flow of a matrix material. In particular, each of the channels 104 may be any conduit formed and/or defined by the ceramic fibers 110. The channels 104 may continuously guide the matrix material through the channel from the inlet 300 to outlet 302. Each of the channels 104 may have one corresponding inlet 300 and one corresponding outlet 302. In some examples, each of the channels 104 is configured to receive the matrix material until the channels 104 are filled with the matrix material along an entire length of each of the channels 104 from the inlet 300 to the outlet 302. FIG. 3B is a schematic view of yet another example of the porous preform 100 in which the channels 104 extend continuously through the preform at a predetermined angle. As shown in FIG. 3 (in other words, FIGS. 3A and 3B), each of the channels 104 has the corresponding inlet 300 and the corresponding outlet 302. Each of the inlets 300 may be defined by one of the pores 200 of the layer 102 positioned at the first side 106 of the porous preform 100. Each of the outlets 302 may be defined by one of the pores 200 of the layer 102 positioned at the second side 108 of the porous preform 100. The channel 104 extends between the inlet 300 and the outlet 302.

As shown in FIGS. 1 and 3, each of the channels 104 extends continuously through the porous preform 100 from the first side 106 to the second side 108. The channels 104 may be a continuous passageway that extends through the porous preform 100. The channels 104 are continuous because they are unimpeded by the ceramic fibers 110 of the first set 112 and/or the second set 114 of the stacked layers 102. In some examples, the channels 104 may extend linearly, in other words, in a straight line, through the porous preform 100. In other examples, the channels 104 may continuously extend along a non-linear path, for example, a sinusoidal, parabolic, or any other non-linear path. Alternatively or in addition, the channels 104 may be orthogonal to the first set 112 and the second set 114 of the ceramic fibers 110.

The diameters 306 of respective channels 104 are determined by the predetermined diameters 202 of each pore 200 that defines the respective channel 104. As shown in FIG. 3, in some examples, the channels 104 may have a uniform diameter 306 throughout the length of the channel 104. In other examples, the diameter 306 of the channels 104 may vary along the length of the channel from the inlet 300 to the outlet 302. The channels 104 may be a defined, predetermined shape. The channels 104 may be a variety of shapes depending on the shape of the pores 200. For example, the channels 104 may be in the shape of a rectangular prism, tube, or any other shape configured to direct a flow of the matrix material continuously through the channel 104.

Alternatively or in addition, as shown in FIG. 3, the layers 102 may be spaced a predetermined distance 308 apart from each other. The spacing of the layers 102 may allow for the matrix material to flow laterally with respect to the channels 104, if, for example, there are any inadvertently misaligned pores 200, such that the channels 104 are at least in part impeded by the ceramic fibers 110. In this example, the porous preform 100 may be configured to direct the matrix material along a surface of each layer 102. The predetermined distance 308 may be the same range as that of the diameter 202 of the pores 200, for example 10F-500F and/or 0.1T-5T.

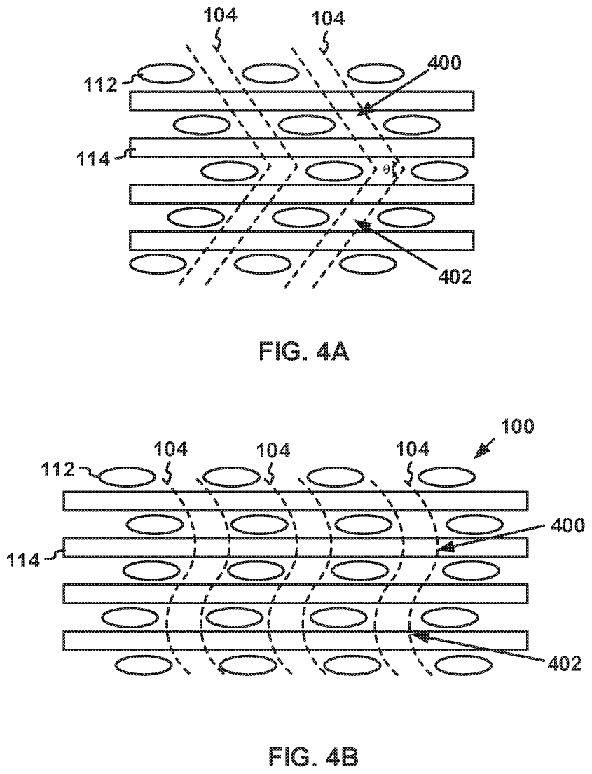

FIG. 4A is a schematic cross-sectional view of another example of the porous preform 100 in which the channels 104 include a first portion 400 and a second portion 402. In some examples, as shown in FIG. 4A, the second portion 402 extends from the first portion 400 at a predetermined angle, θ. The predetermined angle, θ, such that a minimum diameter 202 of the pores 200, for example, 0.1T, is maintained. The predetermined angle, θ, may be between 5 and 180°. In some examples, where a number of layers 102 in the porous preform 100 is small, for example, less than ten layers 102, the predetermined angle may be approximately 5°. In other examples, where the number of layers 102 in the porous preform 100 is large, for example, greater than fifty layers 102, the predetermined angle may be greater than 5° to maintain the minimum pore diameter. In an example, the channel 104 may include multiple first portions 400 and multiple second portions 402 that alternate. In this example, the channel 104 is in a zig-zag pattern.

FIG. 4B is a schematic cross-sectional view of an example of the porous preform 100 in which the first portion 400 and the second portion 402 of the channels 104 are curved or non-linear.

During operation, the layer 102 or layers are formed. The layers 102 include the first set 112 of the ceramic fibers 110 and the second set 114 of the ceramic fibers 110. The first set 112 and the second set 114 are arranged to define the pores 200 therebetween. In some examples, the layers 102 are stacked on top of each other to form the porous preform 100. In other examples, a single layer 102 forms the porous preform 100. The pores 200 of the layers 102 arranged on top of each other are aligned. The layer or layers form a porous preform. In some examples, the porous preform is the porous preform 100. The pores 200 define multiple channels 104 extending continuously through the porous preform 100 from the first side 106 to the second side 108 of the porous preform 100. The porous preform 100 is infiltrated with the matrix material.

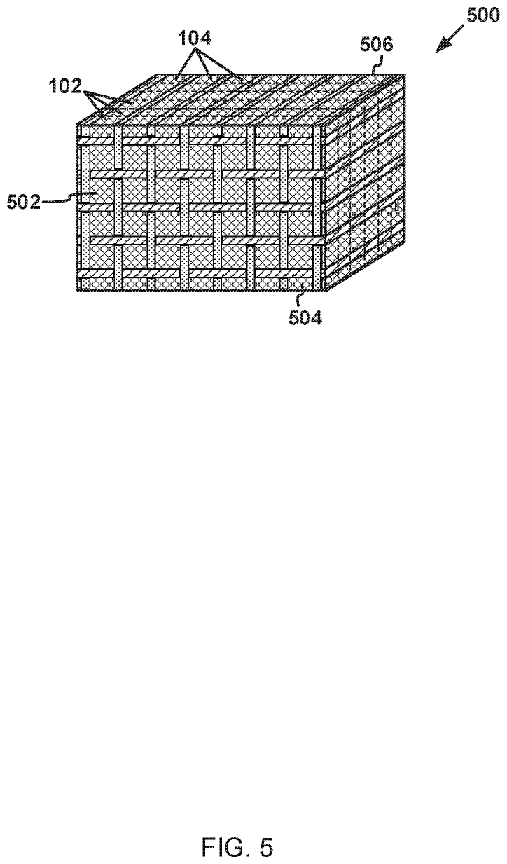

FIG. 5 illustrates a schematic example of a ceramic matrix composite (CMC) component 500. The component includes the layers 102, the channels 104, and the matrix material 502. The channels 104, which have been infiltrated with the matrix material 502, extend from a first side 504 of the CMC component to a second side 506 of the CMC component. In some examples, the infiltrated channels 104 may extend linearly in a straight line through the porous preform 100. In other examples, the channels 104 may continuously extend along a non-linear path, for example, a sinusoidal, parabolic, or any other non-linear path. The matrix material 502 includes a ceramic material, such as, for example, silicon carbide (SiC), silicon nitride (Si₃N₄), alumina (Al₂O₃), aluminosilicate, silica (SiO₂). In some examples, the matrix material 502 additionally may include silicon metal, carbon, or the like. Alternatively or in addition, the matrix material 502 may include mixtures of two or more of SiC, Si₃N₄, Al₂O₃, aluminosilicate, silica, silicon metal, or carbon.

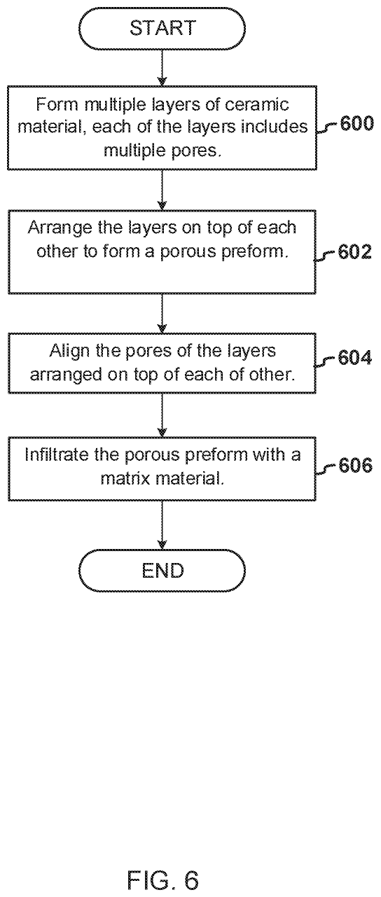

FIG. 6 illustrates a flow diagram of an example of steps to manufacture the CMC component 500. Multiple layers 102 of ceramic material are formed (600). Each of the layers 102 includes a first set 112 and a second set 114 of ceramic fibers 110. The first set 112 is arranged at an angle with respect to the second set 114. The first set 112 and the second set 114 define multiple of pores 200 therebetween. The layers 102 are arranged on top of each other to form a porous preform 100 (602). The pores 200 of the layers 102 arranged on top of each of other are aligned (604). The pores 200 define multiple channels 104 extending continuously through the porous preform 100 from a first side 106 of the porous preform 100 to a second side 108 of the porous preform 100. Each channel 104 includes one inlet 300 at the first side 106 of the porous preform 100 and one outlet 302 at the second side 108 of the porous preform 100. The porous preform 100 is infiltrated with a matrix material (606).

The method may include additional, different, or fewer operations than illustrated in FIG. 6. The steps may be executed in a different order than illustrated in FIG. 6. For example, the infiltration of the porous preform 100 with the matrix material 502 may be performed by different infiltration processes, such as, chemical vapor deposition or chemical vapor infiltration (CVI). Examples of CVI include, but are not limited to, isothermal infiltration with diffusive transport through the preform (i.e. conventional CVI), isothermal infiltration with convection-assisted transport (i.e. forced-flow CVI), temperature or thermal gradient infiltration with diffusive transport, and thermal gradient infiltration with forced flow. In other examples, the infiltration process may include chemical vapor deposition (CVD) interface coating, slurry infiltration, and/or melt infiltration.

Alternatively, in examples where a single 3-D weave defines the porous preform 100 and is a complete porous preform, the method may not include arranging the layers on top of each other (602).

In other examples, the method described herein may be further implemented in the production of carbon fibrous substrates.

Each component may include additional, different, or fewer components. For example, the CMC component 500 may be a non-oxide (SiC/SiC) CMC. In another example, the matrix material 502, which is chemically deposited, may include only a thin layer or coating, for example, a metallic carbide, oxide, boride, or nitride. In this example the method may further include a first application of the thin layer or coating and then at least one sequential application to construct complex coating systems.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

While various embodiments have been described, it will be apparent to those of ordinary skill in the art that many more embodiments and implementations are possible. Accordingly, the embodiments described herein are examples, not the only possible embodiments and implementations.

The subject-matter of the disclosure may also relate, among others, to the following aspects:

A first aspect relates to a method comprising: forming a plurality of layers, each of the layers including at least a first set of ceramic fibers and a second set of ceramic fibers, wherein the first set is arranged at an angle with respect to the second set, wherein the first set and the second set define a plurality of pores therebetween; arranging the layers on top of each other to form a porous preform; aligning the pores of the layers arranged on top of each other, wherein the pores define a plurality of channels extending continuously through the porous preform from a first side of the porous preform to a second side of the porous preform, wherein each channel comprises one inlet at the first side of the porous preform and one outlet at the second side of the porous preform; and infiltrating the porous preform with a matrix material.

A second aspect relates to the method of the first aspect, wherein the aligning the pores further comprises aligning the first set of ceramic fibers of each layer with the first set of ceramic fibers of respective layers and aligning the second set of ceramic fibers of each layer with the second set of ceramic fibers of the respective layers.

A third aspect relates to the method of any preceding aspect, wherein the channels are orthogonal to the layers arranged on top of each other.

A fourth aspect relates to the method of any preceding aspect, wherein the channels extend linearly through the porous preform.

A fifth aspect relates to the method of any preceding aspect, wherein the channels oscillate through the porous preform from the first side to the second side in a linear zig-zag pattern.

A sixth aspect relates to the method of any preceding aspect, wherein the channels oscillate through the porous preform from the first side to the second side in a non-linear zig-zag pattern.

A seventh aspect relates to the method of any preceding aspect, wherein the infiltrating the channels with the matrix material comprises infiltrating by chemical vapor infiltration (CVI).

An eighth aspect relates to the method of any preceding aspect, wherein the first set of ceramic fibers and the second set of ceramic fibers form a two-dimensional weave.

A ninth aspect relates to the method of any preceding aspect, wherein the porous preform is a complete porous preform for a component of a gas turbine engine.

A tenth aspect relates to a method comprising: forming at least one layer of ceramic fibers, the at least one layer comprising a complete porous preform, the at least one layer including a plurality of pores, which define a plurality of channels extending continuously through the complete porous preform from a first side of the complete porous preform to a second side of the complete porous preform, wherein each channel comprises one inlet at the first side of the complete porous preform and one outlet at the second side of the complete porous preform; and infiltrating the complete porous preform with a matrix material.

An eleventh aspect relates to the method of any preceding aspect, wherein the at least one layer is a 3-D weave of the ceramic fibers.

A twelfth aspect relates to the method of any preceding aspect, wherein the at least one layer comprises a plurality of layers, wherein each layer is a two dimensional weave of the ceramic fibers.

A thirteenth aspect relates to the method of any preceding aspect, further comprising arranging the layers on top of each other to form the complete porous preform.

A fourteenth aspect relates to the method of any preceding aspect, further comprising arranging the layers a predetermined distance apart, wherein the predetermined distances in a range of 10 to 500 times a width of a fiber of the ceramic fibers.

A fifteenth aspect relates to the method of any preceding aspect, wherein the infiltrating the complete porous preform with the matrix material comprises infiltrating by melt infiltration.

A sixteenth aspect relates to a ceramic matrix composite (CMC) component comprising: ceramic fibers embedded in a matrix material, wherein a plurality of infiltrated channels comprising the matrix material extend from a first side of the CMC component to a second side of the CMC component, and wherein the first side is opposite of the second side.

A seventeenth aspect relates to the CMC component of any preceding aspect, wherein the infiltrated channels extend straight through the CMC component.

An eighteenth aspect relates to the CMC component of any preceding aspect, wherein each of the infiltrated channels comprises a first portion and a second portion, wherein the first portion is arranged at a predetermined angle with respect to the second portion.

A nineteenth aspect relates to the CMC component of any preceding aspect, wherein and the second portion of the infiltrated channels repeat and alternate through the CMC component in a zig-zag pattern.

A twentieth aspect relates to the CMC component of any preceding aspect, wherein the infiltrated channels have a predetermined diameter in a range of 10 to 500 times a width of a fiber of the ceramic fibers.

In addition to the features mentioned in each of the independent aspects enumerated above, some examples may show, alone or in combination, the optional features mentioned in the dependent aspects and/or as disclosed in the description above and shown in the figures.

1. A method comprising:
forming a plurality of layers, each of the layers including at least a first set of ceramic fibers and a second set of ceramic fibers, wherein the first set is arranged at an angle with respect to the second set, wherein the first set and the second set define a plurality of pores therebetween;
arranging the layers on top of each other to form a porous preform;
aligning the pores of the layers arranged on top of each other, wherein the pores define a plurality of channels extending continuously through the porous preform from a first side of the porous preform to a second side of the porous preform, wherein the pores are aligned such that each channel extends orthogonal to the layers arranged on top of each other, and such that each channel is defined by a respective set of pores and has a uniform diameter that is equal to diameters of the respective set of pores, and wherein each channel comprises one inlet at the first side of the porous preform and one outlet at the second side of the porous preform; and
infiltrating the porous preform with a matrix material.

2-6. (canceled)

7. The method of claim 1, wherein the infiltrating the channels with the matrix material comprises infiltrating by chemical vapor infiltration (CVI).

8. The method of claim 1, wherein the first set of ceramic fibers and the second set of ceramic fibers form a two-dimensional weave.

9. The method of claim 1, wherein the porous preform is a complete porous preform for a component of a gas turbine engine.

10. A method comprising:
forming a plurality of layers of ceramic fibers, the plurality of layers comprising a complete porous preform, the plurality of layers including a plurality of pores defining a plurality of channels extending continuously through the complete porous preform from a first side of the complete porous preform to a second side of the complete porous preform, wherein the pores are aligned such that each channel extends orthogonal to the plurality of layers arranged on top of each other, and such that each channel is defined by a respective set of pores and has a uniform diameter that is equal to diameters of the respective set of pores, and wherein each channel comprises one inlet at the first side of the complete porous preform and one outlet at the second side of the complete porous preform; and
infiltrating the complete porous preform with a matrix material.

11. The method of claim 10, wherein each of the plurality of layers is a 3-D weave of the ceramic fibers.

12. The method of claim 10, wherein each of the plurality of layers is a two dimensional weave of the ceramic fibers.

13. The method of claim 12, further comprising arranging the layers on top of each other to form the complete porous preform.

14. The method of claim 13, further comprising arranging the layers a predetermined distance apart, wherein the predetermined distances in a range of 10 to 500 times a width of a fiber of the ceramic fibers.

15. The method of claim 10, wherein the infiltrating the complete porous preform with the matrix material comprises infiltrating by melt infiltration.

16-20. (canceled)
